(19) United States
(12) Patent Application Publication
(10) Pub. No.: US 2011/0274847 A1
(43) Pub. Date: Nov. 10, 2011

(54) UNIVERSAL ACTUATOR FOR COATINGS

(75) Inventor: Albert Parks, Stafford, VA (US)

(73) Assignee: RICHARD PARKS CORROSION TECHNOLOGIES, INC., Stafford, VA (US)

(21) Appl. No.: 13/143,471

(22) PCT Filed: Jan. 25, 2010
(86) PCT No.: PCT/US10/22019

§ 371 Date: Jul. 6, 2011

Related U.S. Application Data
(60) Provisional application No. 61/146,921, filed on Jan. 23, 2009.

(51) Int. Cl. B05C 11/00; B05D 1/28; B05D 1/02; B05C 1/00; B05C 5/00

(52) U.S. Cl. 427/421.1; 118/200; 118/264; 118/300; 118/612; 427/428.01; 427/429

(57) ABSTRACT

An actuator device for applying a single or multi-component coating, which comprises: at least one universal attachment port configured to connect to one or more of a spray attachment, brush, applicator pad, or roller; a throughway configured to secure and/or position at least one feed tube in or on the actuator; and a trigger configured to control a remote coating liquid dispensing system, wherein when in operation the feed tube is capable of fluidly conducting one or more coating liquids from the remote coating liquid dispensing system to one or more selected from the group consisting of the spray attachment, brush, applicator pad, roller, actuator, universal attachment port, or a combination thereof.

### CROSS REFERENCE TO RELATED APPLICATIONS

The present application claims priority to U.S. Provisional Application Ser. No. 61/146,921, filed Jan. 23, 2009, the entire contents of which are hereby incorporated by reference.

### FIELD OF THE INVENTION

The present application relates to an actuator device for the application of paints and coatings.

### DESCRIPTION OF THE FIGURES

Various embodiments are shown in the figures, which are not intended to be limiting unless otherwise specified, and of which the orientation and description thereof will be readily apparent.

FIG. 1 depicts one embodiment of the actuator device. A trigger is shown, which through a switch is in communication with the remote coating liquid dispensing system. A universal port is shown, which may be suitably configured to attach coating attachments or paint application tools such as sprayer, roller, applicator pad, or brush (not shown) to the actuator. A feed tube is shown, which may suitably conduct coating liquid to the coating attachment from a remote coating liquid dispensing system (not shown). Inbound and outbound pressure lines are shown, of which the inbound pressure line is in fluid communication with a pumping source (not shown) and of which the outbound pressure line is in fluid communication with a remote coating liquid dispensing system. In one embodiment, through the switch, the pressure lines control pressure to the remote coating liquid dispensing system, which in-turn, in one embodiment, controls the flow of coating liquid therefrom.

FIG. 2 depicts one embodiment of a coating attachment. In the figure, a brush attachment is shown. The attachment can be suitably connected to the universal port on the actuator. In one embodiment, the attachment is not connected to the actuator via the universal port, and the housing may be configured for hand held operation by the operator. A feed tube is shown, which may be contained in a housing. A ferrule is shown, which supports the bristles, and in which the paint feed tube is in fluid communication with the paint bristles and conducts coating liquid thereto. In one embodiment, a coating attachment may optionally have an anti-drip port or check valve at the attachment end. In one embodiment, the anti-drip mechanism, check valve, or the like is in fluid communication with the feed tube and has a ball spring loaded seating mechanism with allows release of coating liquid when under fluid pressure and reseals when the inline pressure is decreased. The anti-drip check valves can have different spring loading to control fluid flow allowing mixed paint to flow through the attachment and, in the brush embodiment shown, into the brush head through a tube inside the brush attachment. The mixed paint exits the assembly and into the back of the brush.

FIG. 3 depicts one embodiment of a coating attachment. One embodiment of a roller attachment is shown. In the embodiment, the liquid coating may flow through the roller attachment and into the roller head through a hollow roller brace and paint feed tube housing. The housing may be suitably configured for hand-held operation in the case wherein the coating attachment is not attached to the actuator via the universal port. The anti-drip or check valve attachment may be optionally present.

FIG. 4 depicts one embodiment of a coating attachment. One embodiment of a spray attachment is shown. The paint feed tube is fluidly connected to the spray tip head. When in operation, the liquid coating, e.g., mixed or single component paint is conducted through the feed tube and into the spray tip head. An atomization gas line supplies atomization gas to spray the coating liquid onto a surface. A spray atomization pattern is artistically depicted. An anti-drip or check valve attachment may be present in the feed tube line.

FIG. 5 depicts a cutaway perspective view of one embodiment of the actuator device attached to one embodiment of a coating attachment. One example of a feed tube, which in one embodiment is configured to deliver coating liquid from the remote coating liquid dispensing system, is shown. One example of inbound and outbound pressure lines are shown, of which in one embodiment the inbound pressure line is in pneumatic or fluid contact with a pumping source (not shown) and of which in one embodiment the outbound pressure line is in pneumatic or fluid contact with the remote coating liquid dispensing system (also not shown). In this embodiment, the trigger is connected to a switch, which, in turn, acts as a gate or valve which when opened allows pressurized gas in the inbound line from the pumping source, through the switch, into the outbound pressure line and thus to the remote coating liquid dispensing system. The outbound pressure line, in turn, pressurizes a pneumatic driver (not shown) at the remote coating liquid dispensing system. The pneumatic driver drives one or more pneumatic rams (not shown) on the remote coating liquid dispensing system, which forces a single or multiple coating liquid out of one or more cartridges mounted in the remote coating liquid dispensing system, through the paint feed tube, and to the coating attachment. A pressure relief device may be optionally inserted in the inbound pressure line to bleed off excess pressure in the line as appropriate for safety or the like. One embodiment of a universal attachment port is also shown, which in FIG. 5 includes the female component of a Luer lock. The corresponding attachment point (e.g., a male Luer lock) is shown on the coating attachment (e.g., a brush attachment as shown). In one embodiment, the paint feed tube may suitably enters the coating attachment through a side port, wherein when in operation the coating liquid is supplied to an interior portion of the brush head and thereon to the bristles.

FIG. 6 depicts a side view of one embodiment of the actuator device shown in FIG. 5. In one embodiment, the actuator body is suitably configured for comfortable hand-held operation. As shown, quick connects or similar connections may be suitably provided for connecting and disconnecting the inbound and outbound pressure lines to the actuator. In FIG. 6, the quick connects for the inbound and outbound pressure lines are shown at the back end of the actuator device, but other embodiments are possible.

FIG. 7 depicts an end-on view from the front end of the actuator device shown in FIG. 6. The front portion of the trigger is shown, which trigger may be suitably configured to rotate about a hinge. The paint feed tube is secured on the external portion of the actuator body.

FIG. 8 depicts a perspective, non-cutaway view of the actuator. The actuator body may be suitably made from any material, such as polymer, metal, or the like. In one embodiment, the actuator body may be suitably made from a two piece molded polymer, in which the two pieces may be connected together with screws, such as shown.

FIG. 9 depicts a perspective view of one embodiment of the actuator device, wherein more detail of one embodiment of a throughway is provided. One embodiment of an external throughway is shown, which includes a concave groove running along the longitudinal axis of the actuator device body, and a series of bosses suitably located along both sides of the groove. The concave or suitably shaped groove may be suitably sized to secure and position the feed tube on the actuator body, may work in concert with the bosses to secure and position the feed tube on the actuator body. In one embodiment, the feed tube may be flexible tubing and may be pressed into the groove and held by the bosses along its length. Other embodiments are possible for the throughway, for example, a side-mounted longitudinal hard tube through which the feed tube may be run, an opening or passageway through the interior of the actuator through which the feed tube may be run, a snap-open and snap-closed cover on the actuator configured to secure and position the feed tube, and the like.

FIG. 10 depicts one embodiment of the actuator device in combination with one embodiment of a coating attachment (e.g., a roller device). In the embodiment shown in the figure, the paint feed tube is fluidly connected with an interior portion of a paint spreader chamber, which applies the coating liquid to the exterior portion of the roller head. The roller head and paint spreader chamber are supported by a support arm, which is connected in-turn to the attachment art and subsequently to the universal port via corresponding connectors, e.g., male and female Luer lock.

FIG. 11 depicts two views of one embodiment of the actuator device, wherein the actuator is shown together with a coating attachment (though not shown as connected via the universal port in the figure). In one embodiment, such as shown, a length of flexible paint feed tube is allowed to extend between and fluidly connecting the actuator device and the coating attachment. When in operation, the operator may suitably and easily control the amount and/or flow of coating liquid into the paint feed tube using one hand to hold the actuator device and operate the trigger, and using the other hand to hold the coating attachment and apply the coating liquid to the surface. This may be an advantage as the coating attachment may be lighter and easier to articulate than the combined actuator and coating attachment.

FIG. 12 depicts front and back views of one embodiment of the remote coating liquid dispensing system. Inbound and outbound pressure lines are shown, which fluidly connect the pneumatic driver, optionally through a regulator, to the pumping source or actuator as appropriate. The pneumatic driver, when pressurized, drives one or more pneumatic rams into one or more single or multicomponent coating cartridges, which in turn pushes the coating liquid through a feed tube outlet, feed tube, static mixer, or the like.

FIG. 13 depicts a perspective view of one embodiment of the remote coating liquid dispensing system shown in FIG. 12. In the embodiment shown, the remote coating liquid dispensing system includes a series of hooks, which are configured to suspend the remote coating liquid dispensing system from a suitable support, such as a wall, railing, ladder, or the like. One embodiment of an actuator and coating attachment is also shown.

FIGS. 14-25 show schematic diagrams of several embodiments, in which several components and their respective connectivities are shown. The arrows represent flow direction between fluidly connected (pneumatic or pressure line gas, atomization gas, or coating liquid as appropriate) system components. The fluid connections, e.g., for pneumatic or pressure line gas, atomization gas, or coating liquid, may suitably be comprised of flexible hose, e.g., TYGON™, polyethylene, nylon, pvc, rubber, vinyl, silicone, polybutylene, combination thereof, and the like.

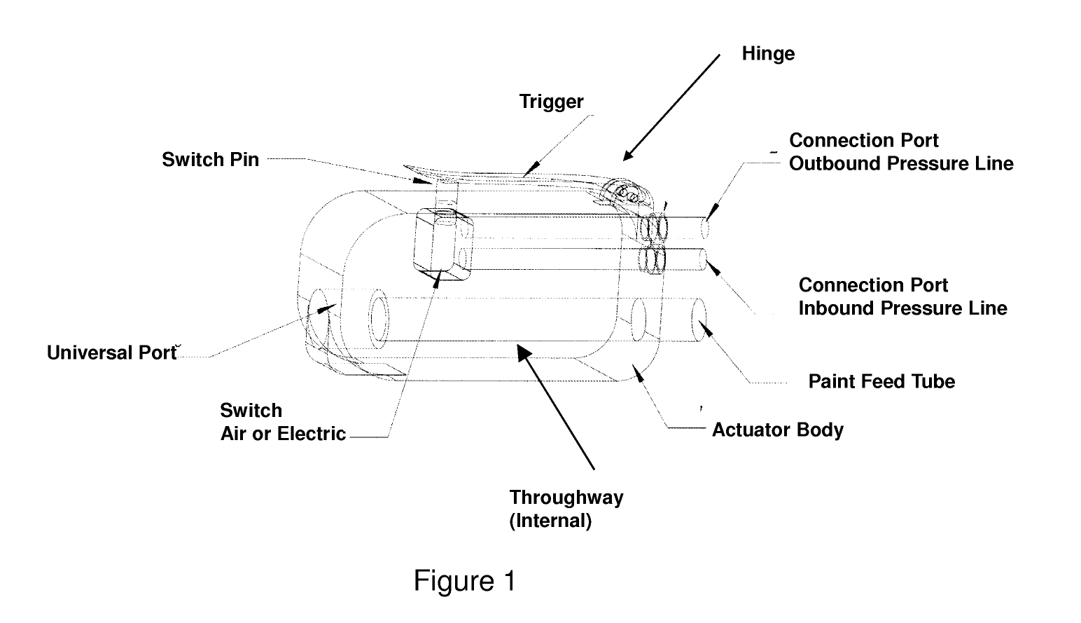

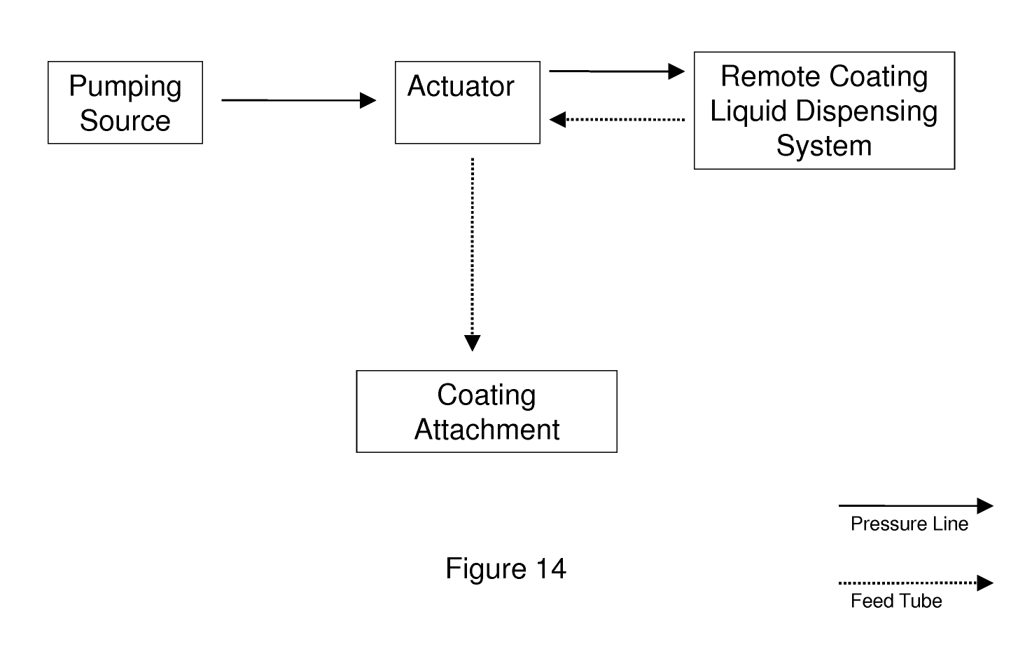

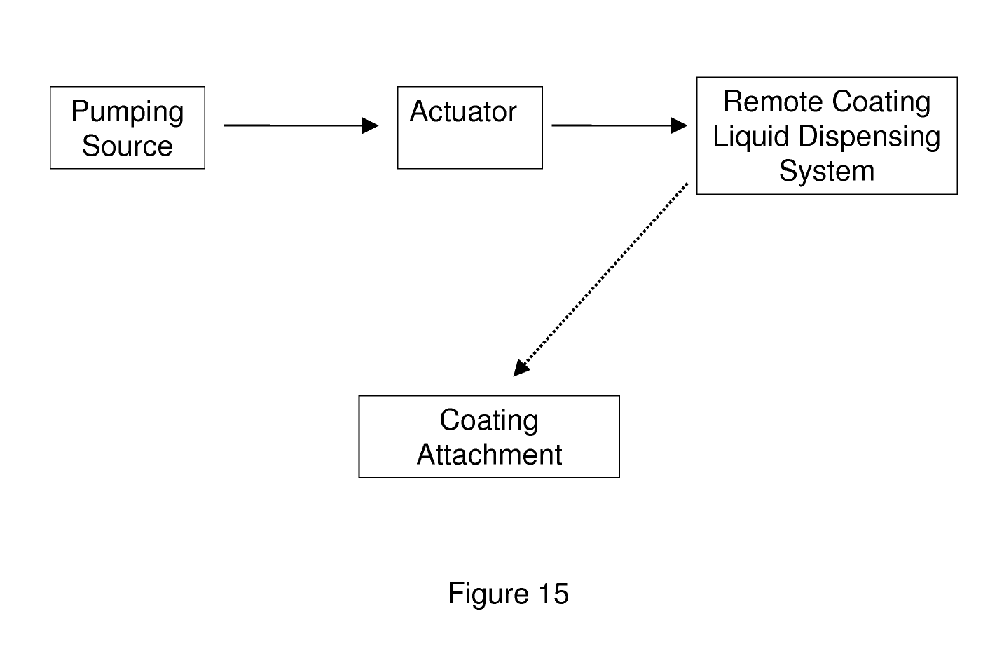

In the legend in the lower right-hand corner of FIG. 14, the pressure line is shown as a solid arrow, with arrow direction showing the direction of fluid (pressurized line gas) flow. The solid arrow represents pneumatic gas that originates in the pumping source and drives the remote coating liquid deliver system. The dotted arrow in the legend represents the coating liquid feed tube, with the arrow direction showing the direction of fluid (unmixed multicomponent coating liquid, mixed multicomponent coating liquid, or single component coating liquid). A single coating liquid arrow may suitably represent one, two, or more feed tube lines, depending on whether unmixed multicomponent coating liquid (two or more feed tube lines), mixed multicomponent coating liquid (single feed tube line), or single component coating liquid (single feed tube line) are being carried. In one embodiment, when a multicomponent liquid coating is used, a static mixer is inserted as appropriate at a location along the feed tube line. The static mixer mixes the components of multicomponent coating liquid (e.g., epoxy resin and catalyst) into a single mixed multicomponent coating liquid. Upstream of the static mixer, the multiple coating liquid components are kept separate, e.g., in separate cartridges and/or separate feed tubes. Upon passing through the static mixer, the multiple coating liquid components are mixed, and exit the static mixer in a single feed tube. In one embodiment, the coating liquid is a single coating liquid, and a static mixer is not used.

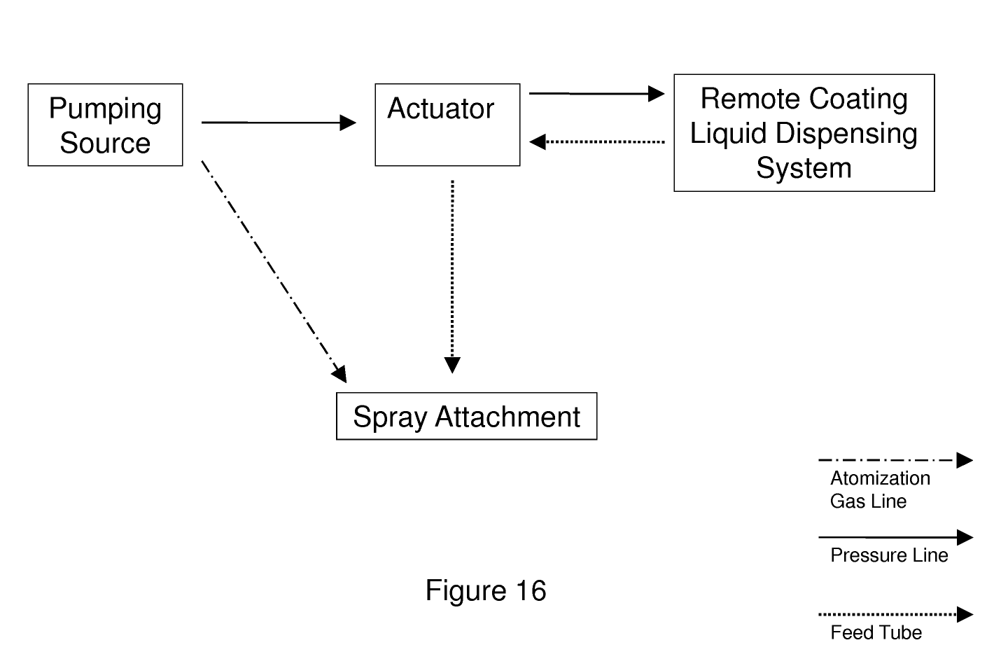

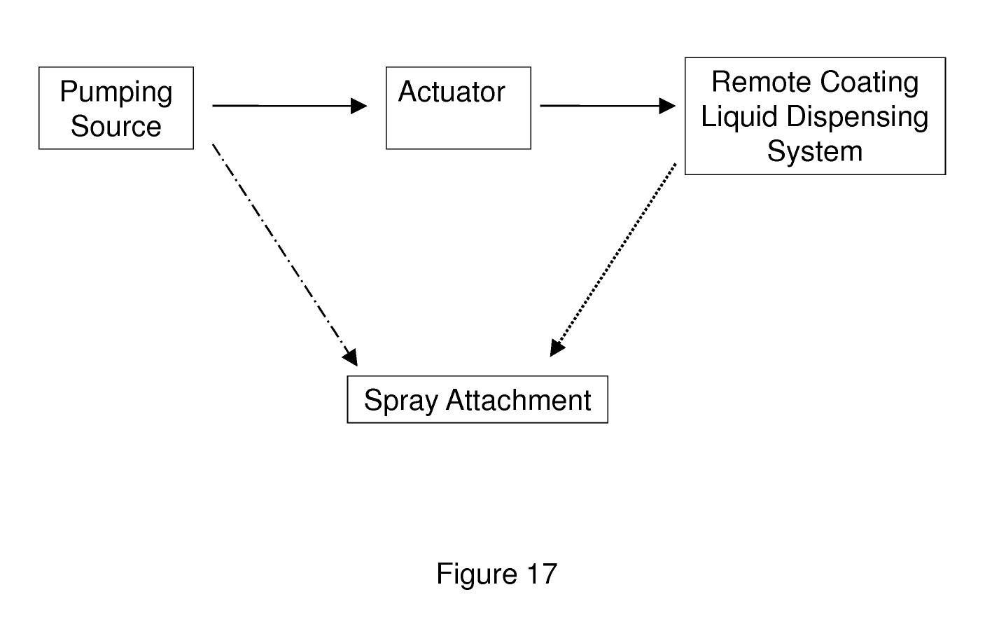

In the legend in the lower right-hand corner of FIG. 16, an atomization gas line is shown as a dashed-dotted arrow, with arrow direction showing the direction of fluid (pressurized atomization gas) flow. The atomization gas suitably atomizes the coating liquid and sprays it from the spray tip of the spray attachment.

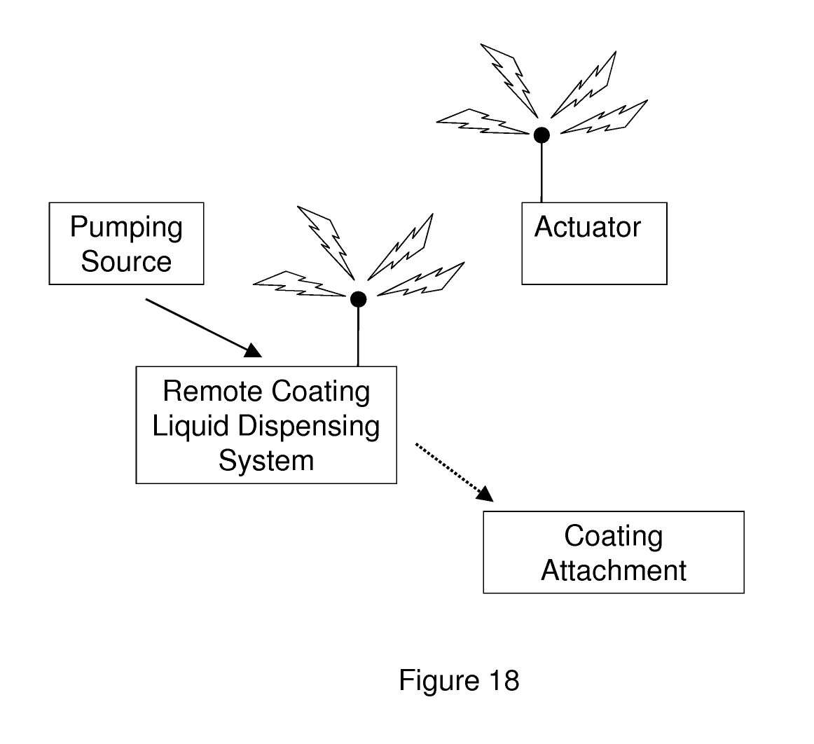

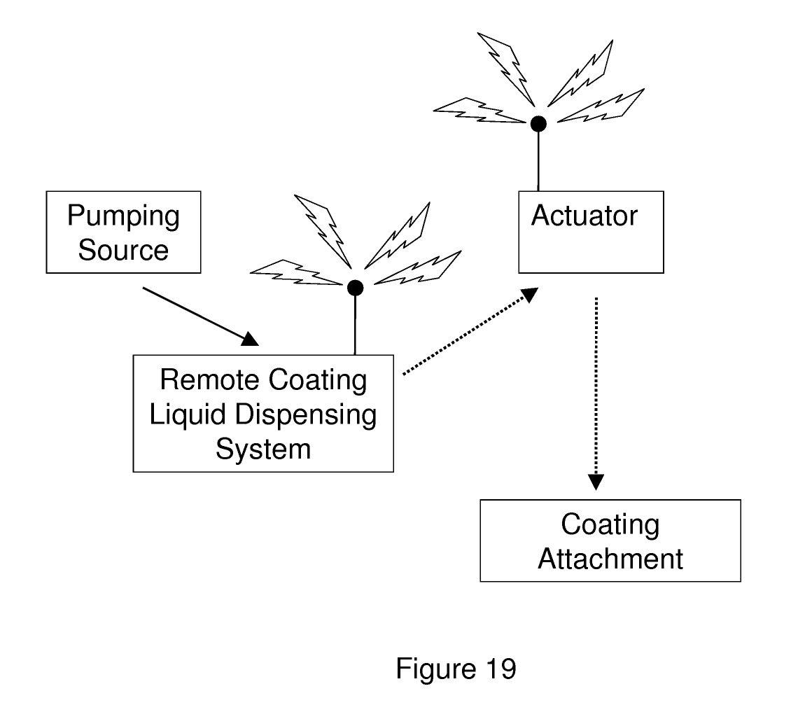

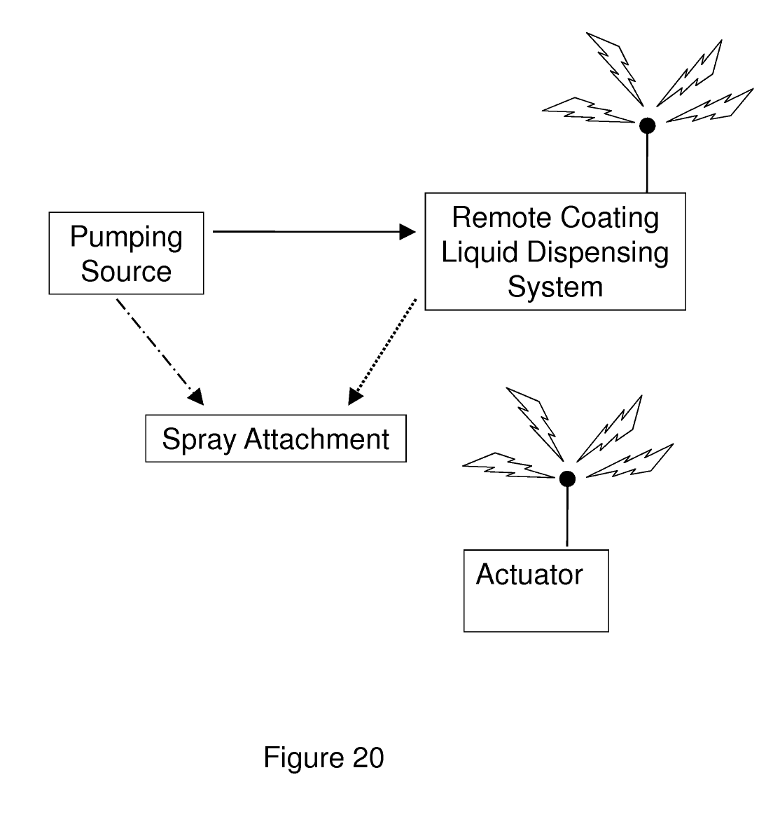

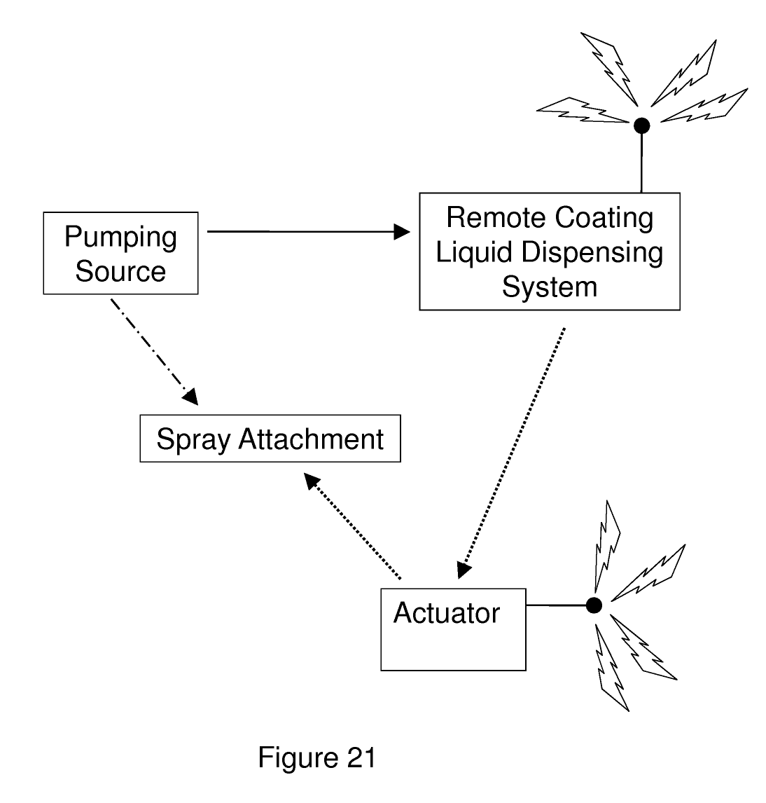

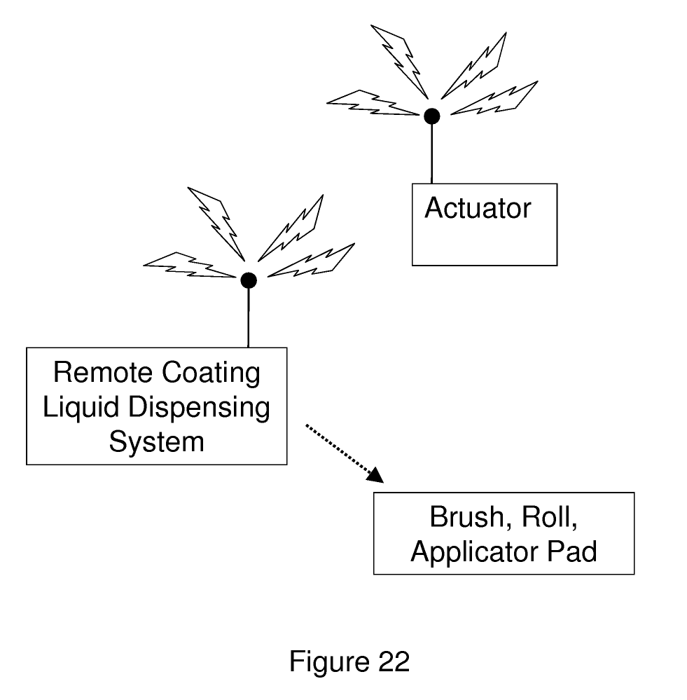

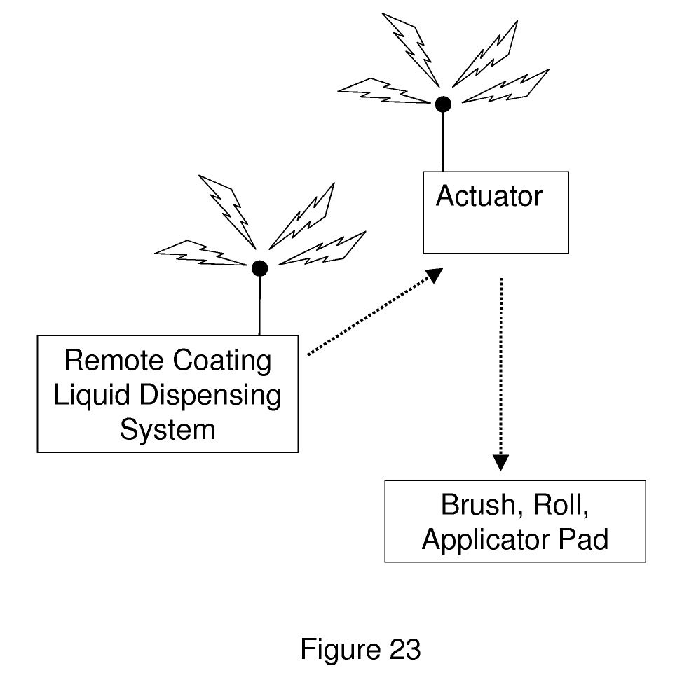

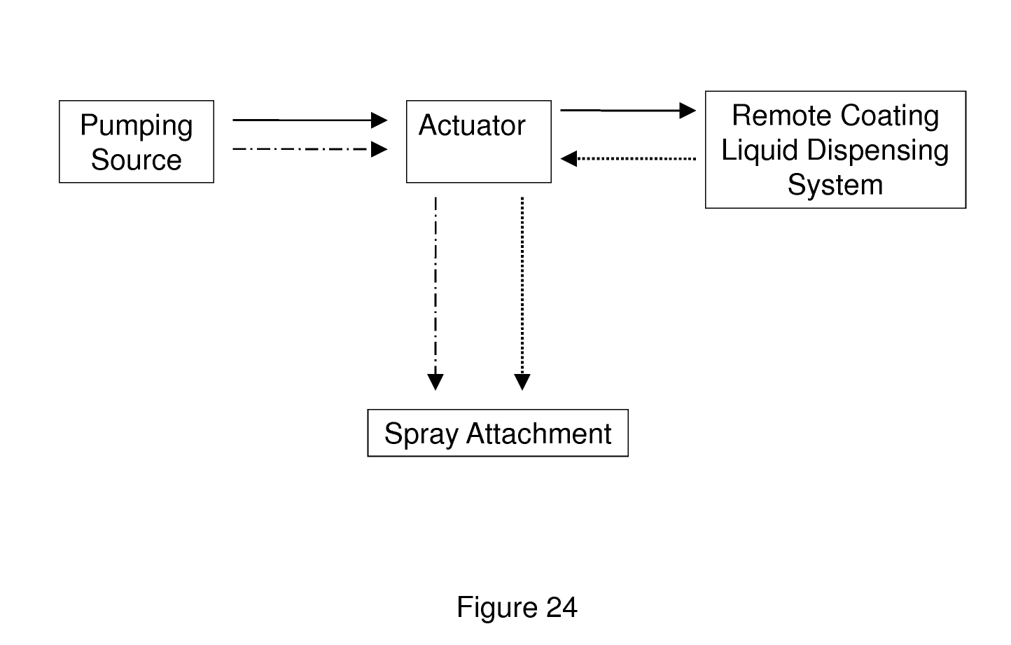

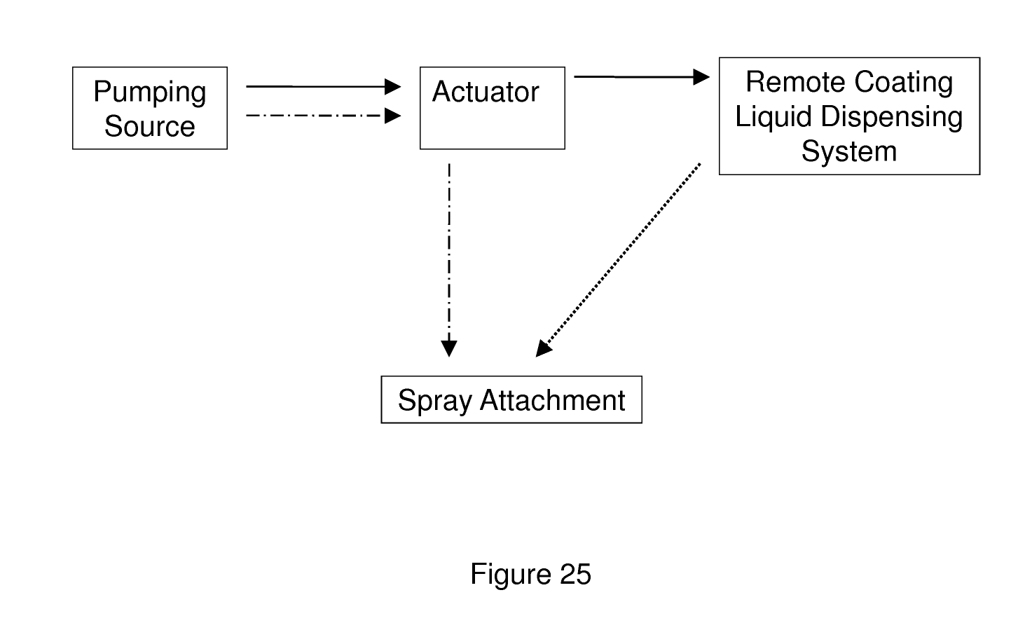

FIGS. 18-23 depict several embodiments wherein antennas and wireless signals are artistically depicted at the actuator and remote coating liquid dispensing system. In such embodiments, the actuator can control the remote coating liquid dispensing system via wireless communication. In such embodiments, the actuator and/or remote coating liquid dispensing system may suitably include an internal or external power supply such as a battery, electric cord, or a combination thereof.

### DESCRIPTION OF THE SEVERAL EMBODIMENTS

One embodiment relates to an actuator and control device for the delivery and mixing of single and/or multi-component paints and coatings. One embodiment relates to an actuator that remotely controls the precise delivery of single and/or multi-component paints and coatings from a remote coating liquid dispensing system. In one embodiment, the actuator has a universal connection that provides interchangeability with one or more of a spray system, a roller, applicator pad, or brush allowing direct mix, dispense, and application from a remote coating liquid dispensing system. In one embodiment, the remote coating liquid dispensing system is pneumatically controlled via a pneumatic switch in the actuator. In another embodiment, the remote coating liquid dispensing system is electronically controlled via an electronic switch in the actuator and wireless electronic signal therefrom to the remote coating liquid dispensing system.

Coating liquid delivery systems are known. For example, the single or multi-component cartridge-based applicators available from COX North America, Inc., Haslett, Mich., USA may be suitably used. The COX North America, Inc., pneumatic or electric bi-mixer applicators having the model numbers CBA 200C™, or POWERPUSH 7000™ may be suitably used. These are hand-held devices which, given the teachings herein, can be configured to operate remotely in combination with the actuator described herein. Alternatively, applicator devices such as the QUAD 3000™ dispensing system available from Plas-Pak Industries, Inc., Norwich, Conn. USA, may be used.

In one embodiment, the actuator enables the application of paints and/or coatings via one handed operation. One embodiment includes a touch activated trigger that signals a remote coating liquid dispensing system to provide single or multi-component coatings. In one embodiment, the device may suitably include one or more universal attachment ports to which one or more coating attachments may be used interchangeably. In one embodiment, the coating attachments may be suitably selected from the group including spray equipment, paint brush, applicator pad, roller device, or the like, or any combination thereof.

In one embodiment, the spray equipment, roller, applicator pad, or brush supply paint or coating directly from the remote coating liquid dispensing system through one or more flexible hoses.

In one embodiment, the actuator is in pneumatic or electronic communication with and/or controls the remote coating liquid dispensing system by pressure tubing or electronic signal.

In one embodiment, the operator can control the flow and amount of paint or coating dispensed by the remote coating liquid dispensing system by the regulation of air pressure applied to the remote coating liquid dispensing system. The regulation of pressure is easily carried out via a trigger and/or suitable valve at the actuator.

In one embodiment, a single or multi-component paint or coating may be applied to a surface with the actuator.

In any of the embodiments described herein, the coating attachment may be physically connected to the actuator via the universal port. In one such embodiment, the coating attachment is fluidly connected to the paint feed tube, and the paint feed tube is secured or positioned in or on the throughway at the actuator, and the paint feed tube is fluidly connected to the remote coating liquid dispensing system.

In any of the embodiments described herein, the coating attachment is not physically connected to the actuator via the universal port. In one such embodiment, the coating attachment is fluidly connected to the paint feed tube, and the paint feed tube is secured or positioned in or on the throughway at the actuator, and the paint feed tube is fluidly connected to the remote coating liquid dispensing system. In such an embodiment, a suitable length of paint feed tube may be present between the actuator and the coating attachment, wherein the operator can control the delivery of coating liquid using one hand to operate the trigger on the actuator, and hold the coating attachment in the other hand to apply the coating to the surface or object being coated. In another such embodiment, the coating attachment is fluidly connected to the paint feed tube, and the paint feed tube is fluidly connected to the remote coating liquid dispensing system, but the paint feed tube is not secured or positioned in or on the throughway at the actuator. In such an embodiment, the operator can control the delivery of coating liquid using one hand to operate the trigger on the actuator, and hold the coating attachment in the other hand to apply the coating to the surface or object being coated.

In one embodiment, a hand held actuator device is provided for single hand mixing, delivery, and application of a single or multi-component paint or coating through a spray system, brush, applicator pad, or roller in one easy step. The coatings can be single component or multi-component coatings. In one embodiment, the coatings include multi-component or reactive paints. The actuator allows an operator to single-handedly dispense, mix, and directly apply single or multi-component, reactive, paints directly to the application area through a roller, applicator pad, brush, or spray system without having to pre-mix either component.

In one embodiment, the precise amount of paint is metered and controlled, and paint waste is reduced or substantially eliminated. In one embodiment, this provides a controllable application system that eliminates mixing, reduces worker exposure to hazardous materials, reduces the amount of hazardous waste, and reduces the amount of volatile organic compounds (VOC's) released into the environment.

One embodiment is particularly suitable for large and small scale paint touch up applications because it eliminates the need to open and mix large containers of paint, eliminates the need to proportion out the exact amount of each component of paint, and eliminates the need to pre-mix reactive paints which translates into significant cost savings in labor and materials. One embodiment eliminates the need to set up and apply industrial paints by conventional spray, brush, applicator pad, and roller technology. For spray applications, one embodiment eliminates the need for conventional pressure pot spray application, eliminates the need for high pressure spray systems, and eliminates high pressure paint hoses typically used in industrial paint applications. For brush applications, one embodiment eliminates the need for paint can, holders, or trays to hold the paint in while applying paint. It also eliminates the need for continued dipping of a paint brush into a can, and dripping of paint from the brush while performing an application. For paint roller applications, one embodiment eliminates the need for roller pans and waste generated from excess paint remaining in the pan. One embodiment significantly reduces time, cost, and waste compared to standard paint application systems. In one embodiment, the actuator device acts as a remote control and metering tool which activates a remote coating liquid dispensing system to pump liquid coating to the actuator and on to the spray attachment, brush, applicator pad, or roller. Single or multi-component paints or liquid coatings are packaged in one or more containers, for example cans, single and multiple cartridges, single or multiple pouches or bags, aseptic pouches or bags, pressurized closed pots, which are mounted in a remote coating liquid dispensing system. The remote coating liquid dispensing system can be pneumatic, pressurized gas, bottled gas, air compressor, battery, electric. The paint driver can be single or multi-pistons including but not limited to triple or quad pistons. Paint is delivered to the actuator device by a universal triggering device which can be a trigger, valve, or gate device which is air activated, electric or battery operated, or wireless such as BLUETOOTH™ wireless transmitter controller. Paint flow may be regulated by triggering the actuator device which is in pneumatic or electrical or wireless electrical contact with the remote coating liquid dispensing system. Paint is feed through a tube which is connected, for example secured to or positioned on the actuator via a throughway on the actuator and is connected to the brush attachment, applicator pad attachment, roller attachment, or spray tip. This system allows remote power feed of paint for application. Once dispensed from the remote coating liquid dispensing system the coating liquid, if a multicomponent coating is used, it may be suitably mixed by a static mixer which is in-line and located anywhere in the feed tube including at the remote coating liquid dispensing system, at the feed tube outlet at the multicomponent cartridges, downstream of the multicomponent cartridges and upstream of a feed tube, between the cartridges and the actuator, between the cartridges and the coating attachment, between the actuator and the coating attachment, and any combination thereof. Whether upstream or downstream of any of the cartridges, actuator, or coating attachment, the static mixer may be located at the respective cartridge, actuator, or coating attachment, or a flexible feed tube may be interposed between the static mixer and the respective cartridge, actuator, or coating attachment. In other embodiments, one or more feed tubes may be suitably downstream of a multicomponent feed tube and upstream of the source, mid-way in a mixing block, at the actuator device, or within the roller, applicator pad, brush, or spray tip attachment. Any combination of feed tube, static mixer, remote coating liquid dispensing system, and coating attachment, in any order, may be suitably used.

For spray applications, an additional atomization gas line may be used to feed atomization gas (e.g., air or other inert gas) to the spray tip and atomize the liquid paint. The atomization gas pumping source may suitably provide atomization gas, for spraying or atomizing the liquid coating, to the spray equipment. In one embodiment, the atomization gas pumping source may be different from the pumping source that provides pressurized gas to the remote coating liquid dispensing system. In another embodiment, the atomization gas pumping source may be the same device as the pumping source that provides pressurized gas to the remote coating liquid dispensing system, and the pumping source provides pressurized gas to both the remote coating liquid dispensing system and atomization gas to the spray equipment. The atomization pumping source provides the atomization gas, and can be a compressed air line, compressor, or bottled gas.

One or more pressure regulators may be present between the pumping source and the actuator, between the pumping source and the remote coating liquid dispensing system, between the atomization gas pumping source and the coating attachment (e.g., the spray attachment), between the actuator and the coating attachment (e.g., the spray attachment), at the actuator device, at the pumping source, at the atomization gas pumping source, at the remote coating liquid dispensing system, at the spray attachment, or any combination thereof.

The actuator device can incorporate a dual trigger or valve which regulates the compressed air to the spray tip or the dual trigger can remotely regulate air flow from air supply.

In one embodiment, one or more flexible hoses, anti-drip attachments, static mixers, or any combination thereof may be inserted between the universal attachment port and one or more of the spray attachment, brush, applicator pad, or roller.

In one embodiment, the trigger may be a trigger, valve, or gate device which is air activated, electric or battery operated, or wireless such as BLUETOOTH™ which is in communication with the remote coating liquid dispensing system. The actuator can be located at any distance away from the dispensing unit. In one embodiment, the actuator has a universal port for the attachment of paint application tools such as sprayer, roller, applicator pad, or brush to the actuator. In one embodiment, the coating attachments or application tools can be either screwed in or locked by a mechanical attachment such as a Luer-type locking mechanism to the port. These coating attachments or application tools are all interchangeable with the actuator device via the universal port. The actuator has a hose attachment which in one embodiment is pressurized via a remote coating liquid dispensing system. The actuator device has a hose attachment which is in either in direct physical contact or wireless such as blue tooth control to the remote coating liquid dispensing system. This controls pressure on paint packaging system containing single or multi-component paints. The actuator has a switch, which when activated by the trigging source releases pressurized air back to the remote coating liquid dispensing system. In one embodiment, the actuator device provides the worker a one handed, touch control applicator tool that delivers mixed paint to the application tools. The actuator has one or more connection ports which allow quick connection/disconnection to the air hoses controlling the remote coating liquid dispensing system.

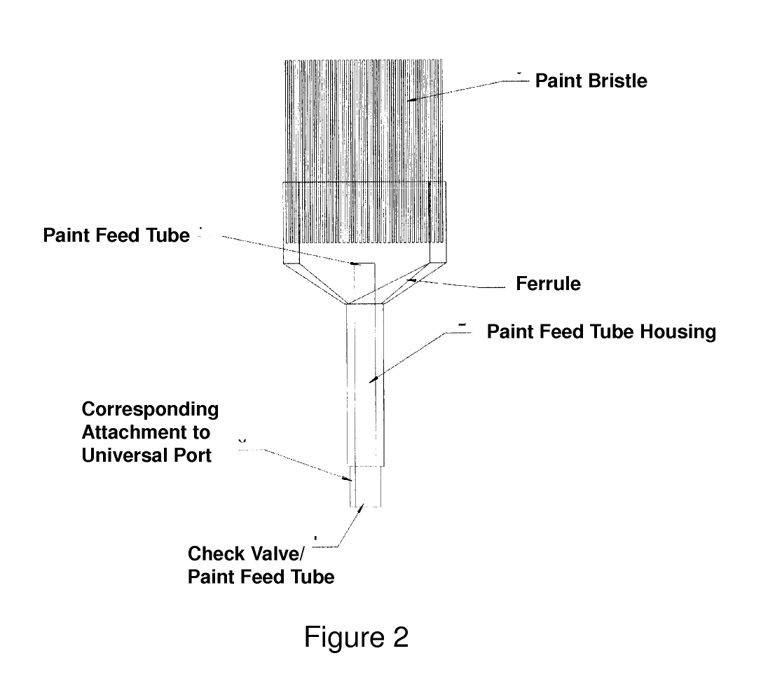

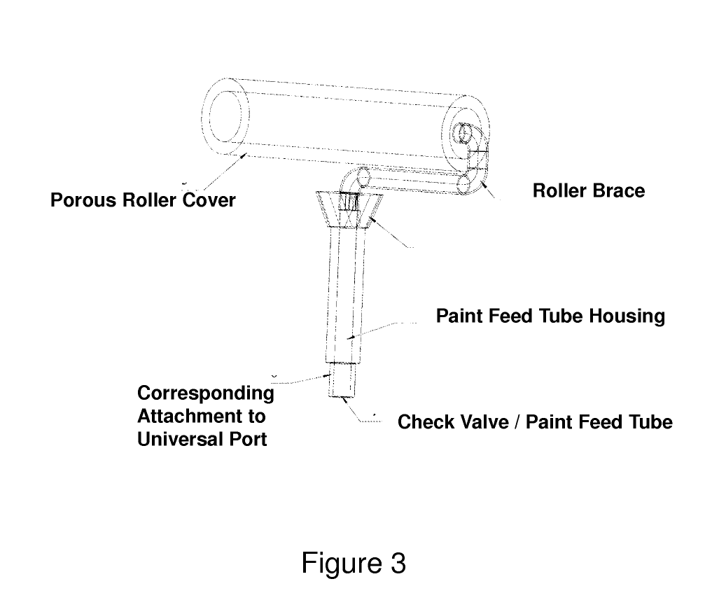

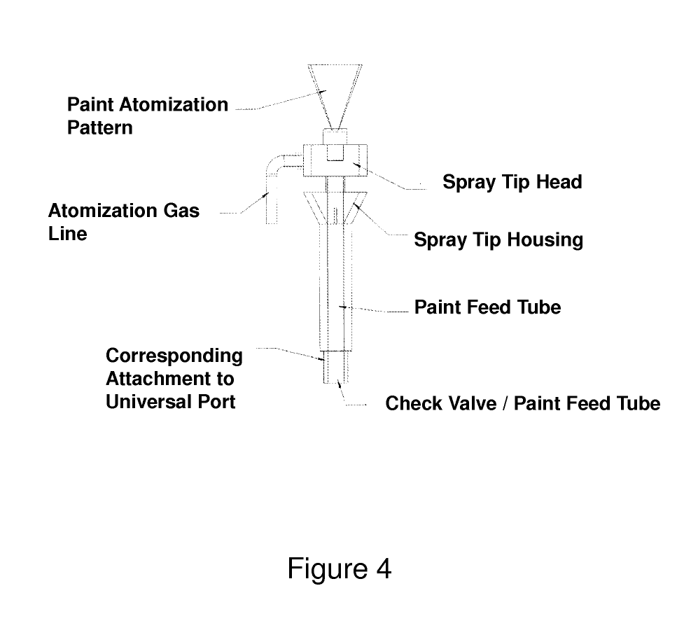

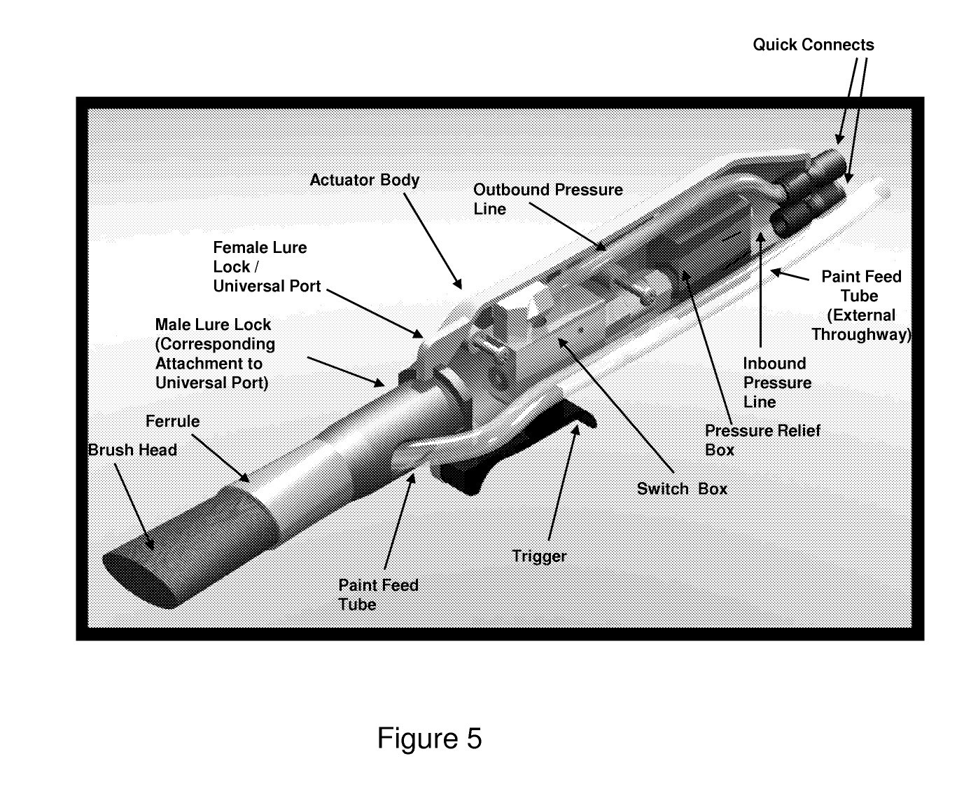

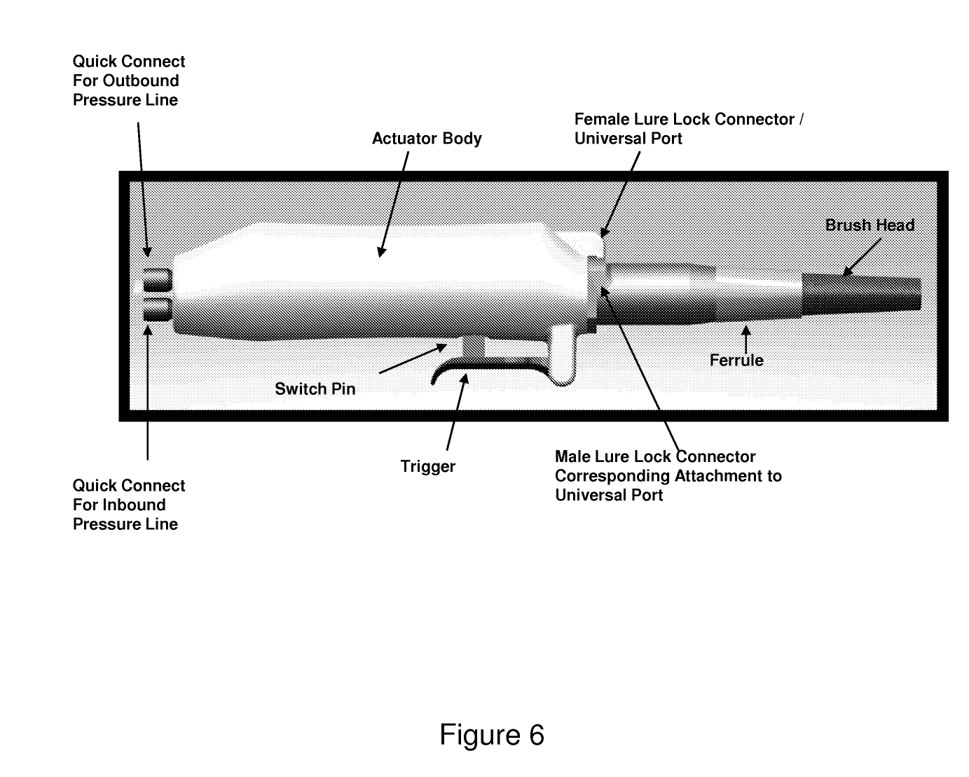

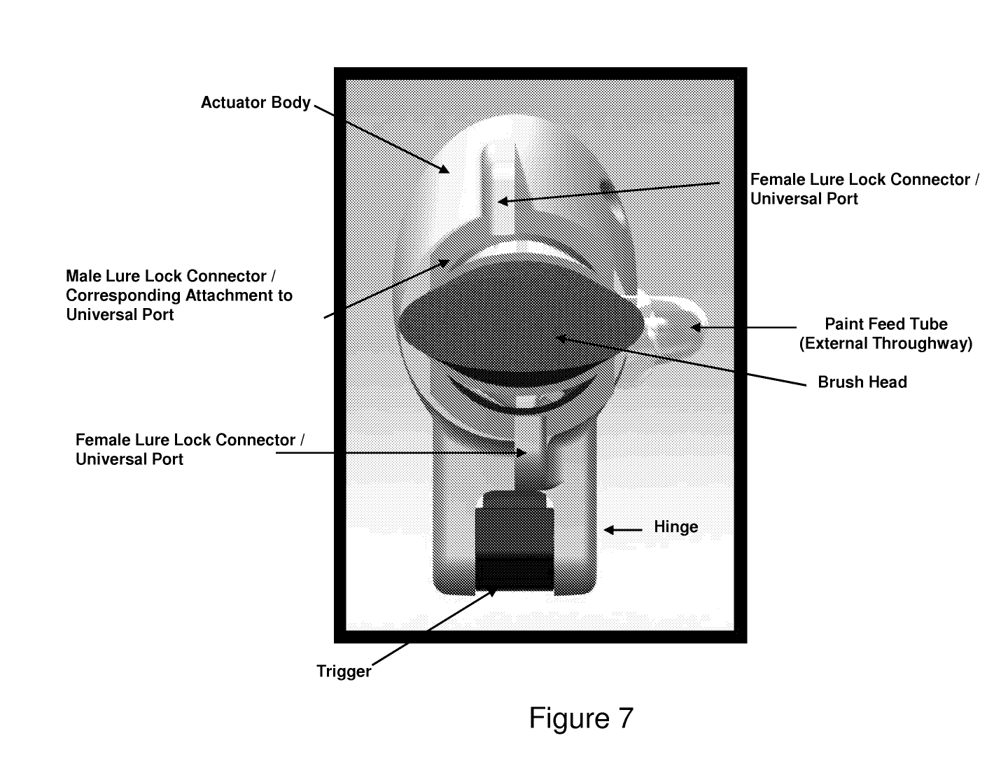

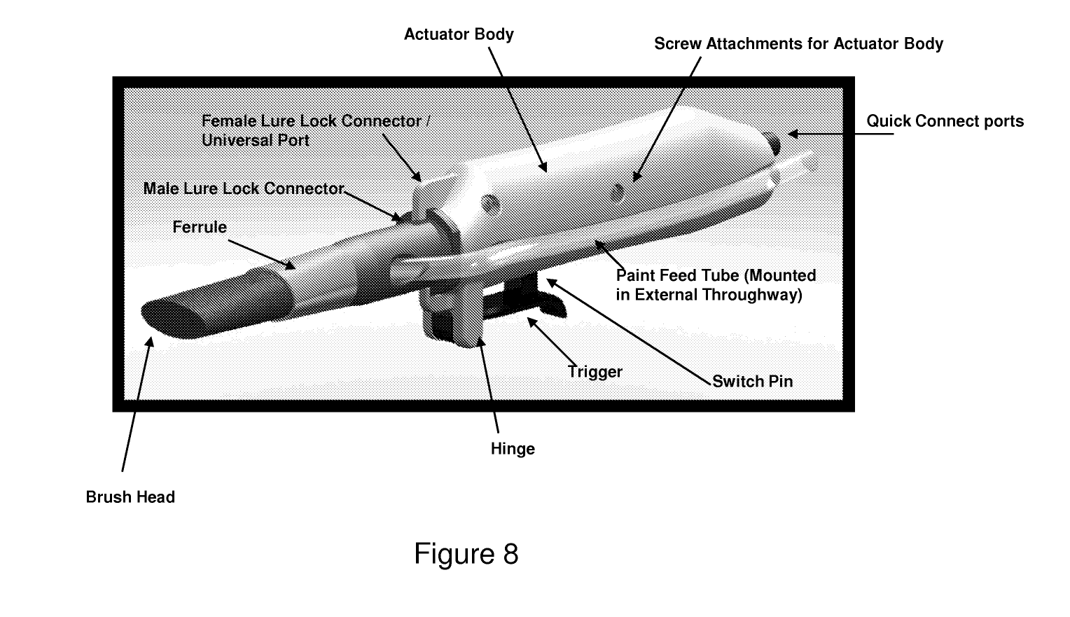

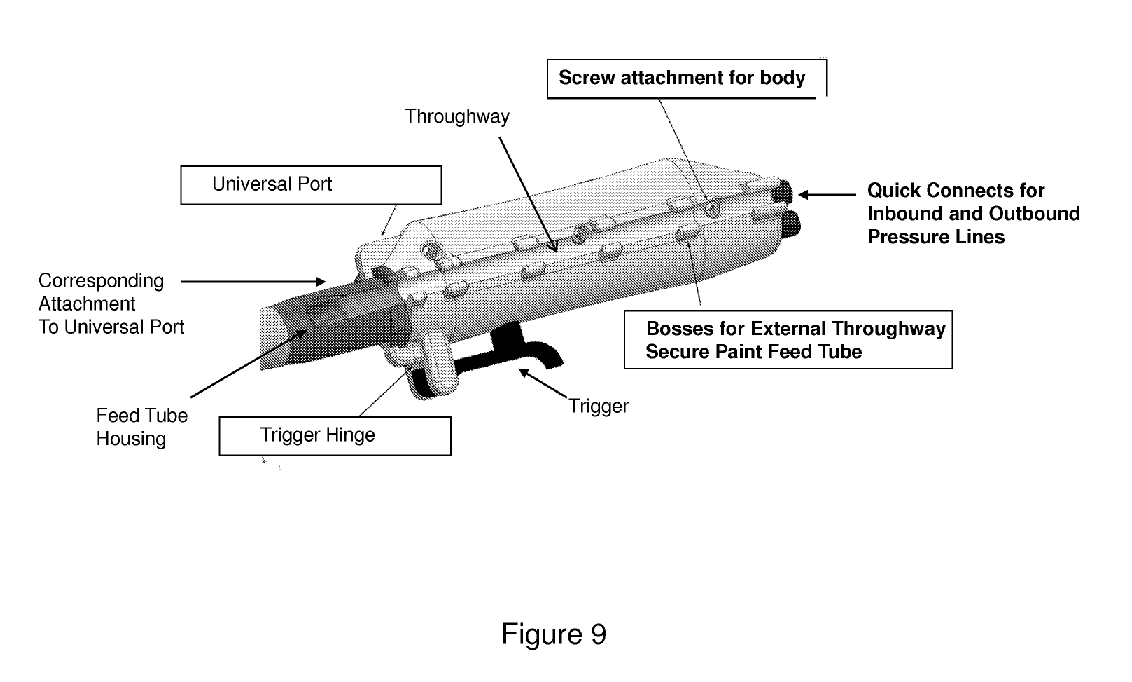

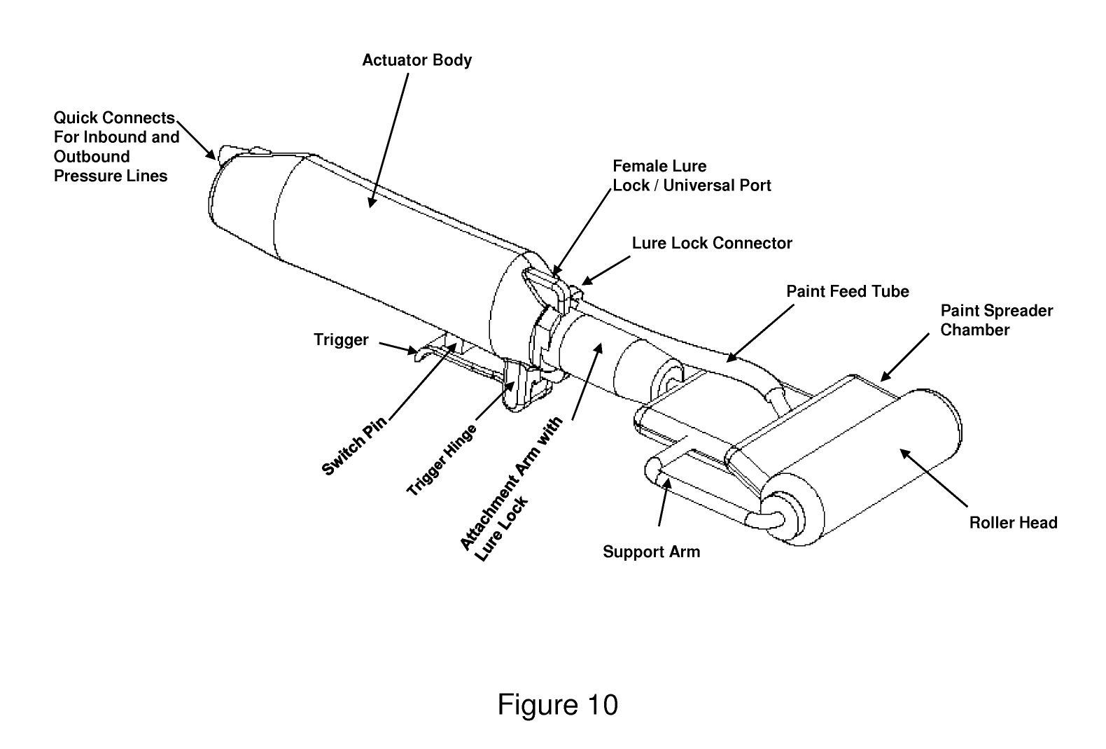

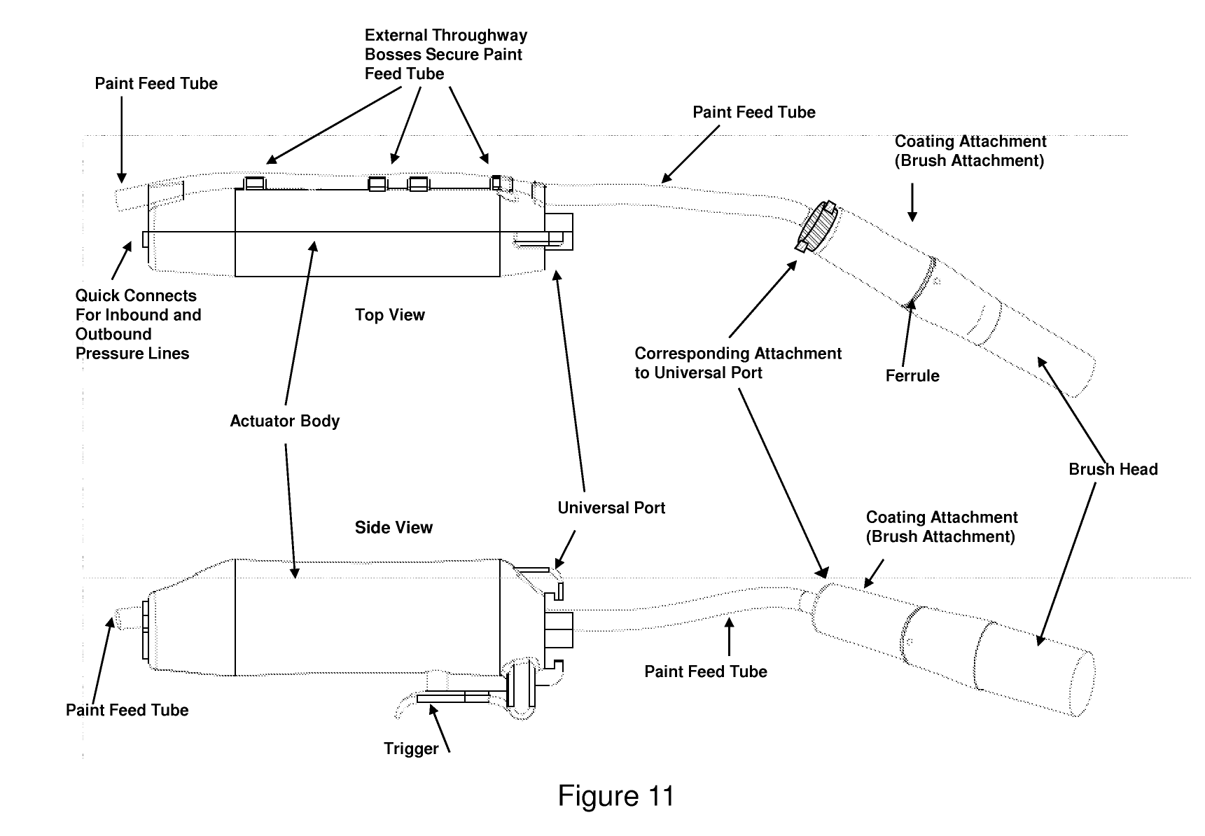

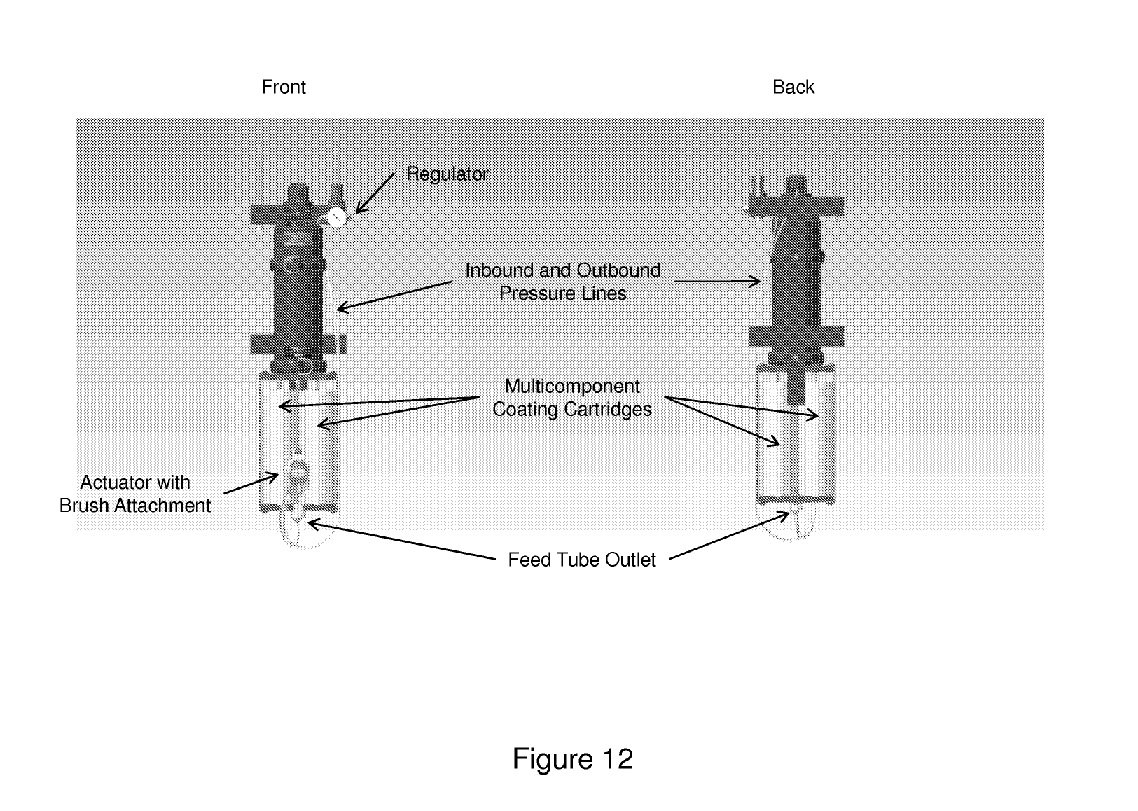

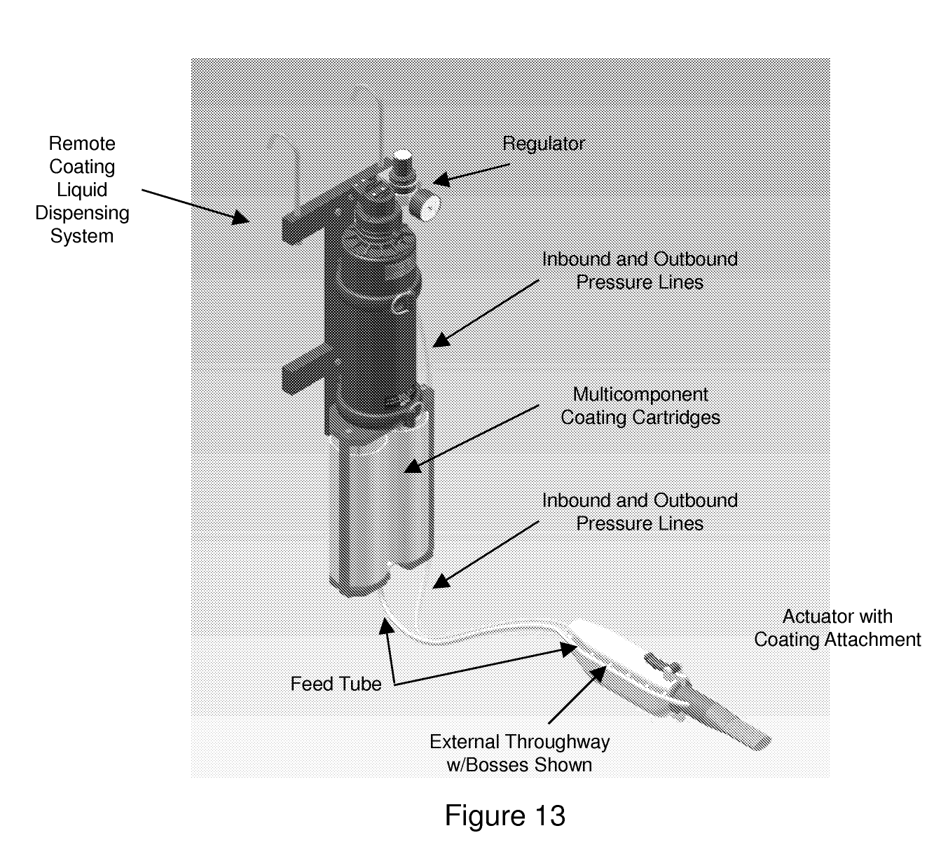

In one embodiment, such as shown in FIG. 2 a brush attachment can be screwed or mechanically attached to the actuator. One embodiment includes a Luer lock attachment. The brush attachment may optionally have an anti-drip port for attachment of a hose that supplies the single or multi-component paint from the remote coating liquid dispensing system. The anti-drip attachment is in line with the paint fluid line and has a ball spring loaded seating mechanism with allows release of paint when under fluid pressure and reseals when the inline pressure is decreased. The anti-drip check valves can have different spring loading to control fluid flow allowing mixed paint to flow through the attachment and into the brush head through a tube inside the brush attachment. The mixed paint exits the assembly and into the back of the brush. Once dispensed from the packaging system the paint is mixed by a static mixer which in line and located anywhere in the fluid line including at the remote coating liquid dispensing system, mid way in a mixing block, at the actuator device, or within the brush. Paint is delivered to the actuator device by a triggering device which can be a trigger, valve, or gate device which is air activated, electric or battery operated, or wireless such as BLUETOOTH™, or any other wireless transmitter controller.

In one embodiment, a roller attachment can be screwed or mechanically attached to the actuator device. In one embodiment, a Luer lock attachment is used. The roller attachment has an anti-drip port for attachment of a hose that supplies the single or multi-component paint from the remote coating liquid dispensing system. The anti-drip attachment allows mixed paint to flow through the roller attachment and into the roller head through a tube attached to the roller. The anti-drip attachment is in line with the paint fluid line and has a ball spring loaded seating mechanism with allows release of paint when under fluid pressure and reseals when the inline pressure is decreased. The antidrip check valves can have different spring loading to control fluid flow Once dispensed from the packaging system the paint is mixed by a static mixer which in line and located anywhere in the fluid line including at the remote coating liquid dispensing system, mid way in a mixing block, at the actuator device, or within the brush. Paint is delivered to the actuator device by a universal triggering device which can be a trigger, valve, or gate device which is air activated, electric or battery operated, or wireless such as BLUETOOTH™, or any other wireless transmitter controller.

In one embodiment, a spray attachment can be screwed or mechanically attached to the actuator. In one embodiment, a Luer lock attachment is used. The spray attachment has an anti-drip port for attachment of a hose that supplies the single or multi-component paint from the remote coating liquid dispensing system. The anti-drip attachment allows mixed paint to flow through the spray attachment and into the spray tip head through a tube inside the spray attachment. The anti-drip attachment is in line with the paint fluid line and has a ball spring loaded seating mechanism with allows release of paint when under fluid pressure and reseals when the inline pressure is decreased. The anti-drip check valves can have different spring loading to control fluid flow. The spray atomization of single or multi-component paint is provided by a pressurized air or gas source such as a compressed air line, compressor, or bottled gas attachment. Pressurized air or inert gas such as nitrogen, argon, oxygen, combination thereof, or the like may be used for the atomization. Once dispensed from the packaging system the paint is mixed by a static mixer which in line and located anywhere in the fluid line including at the remote coating liquid dispensing system, mid way in a mixing block, at the actuator device, or within the brush. The actuator device can incorporate a dual trigger or valve which regulates the compressed air to the spray tip or the dual trigger can remotely regulate air flow from air supply. Paint is delivered to the actuator device by a universal triggering device which can be a trigger, valve, or gate device which is air activated, electric or battery operated, or wireless such as BLUETOOTH™, or any other wireless transmitter controller.

The actuator is particularly useful for applying liquid industrial single and multi-component coatings such as latex, alkyds, acrylics and two component reactive paints, including but not limited to epoxies, urethanes, polyureas, polyaspartic, acrylic, silicone, polyesters, or any combination thereof.

One embodiment enables significant cost savings over complex or expensive meter, mix and dispensing equipment. One embodiment solves the problems of lack of ratio control, inconsistent mixing, and exposure to hazardous materials. The combined savings from the disposal of hazardous waste, elimination of material waste, improved productivity and improved worker safety are significant.

One embodiment offers the flexibility of using single or multi-component coatings. With the actuator a multi-component coating is as easy to use as a single component coating. This is a significant advantage because unlike single component chemistry, multi-component chemistry can be tailored for the particular coating application.

One embodiment enables the reduction of hazardous waste. Typical conventional coating systems, e.g., transferring coatings from one container to another generates large quantities of hazardous waste. When the coating is dispensed using the actuator, a negligible amount of coating remains and can be considered garbage rather than hazardous waste.

One embodiment enables the reduction of material waste. In one embodiment, when using the actuator, the coating is mixed in one or more static mixers as it is dispensed from a single or multi-component cartridge, therefore only the amount needed is prepared. In conventional methods all the coating is mixed at once and any coating material not used within its pot life is wasted. In one embodiment, a two or threefold material savings is obtained.

One embodiment enables perfect ratio control and consistent mixing by eliminating human error. In one embodiment, the actuator is used together with a remote coating liquid dispensing system and coating-containing cartridge, a proper ratio is ensured. In one embodiment, the static mixer or motionless mixer, unlike hand mixing, does not add air to the mixing process, which results in an optimal mixture. In another embodiment, the benefit of mixing on demand or mix while dispensing is achieved, in which nearly all of the coatings work life is available. It is often the case that conventional systems waste a coatings work life and can prevent preferred coatings from being practical for some applications.

One embodiment enables improved employee productivity. Conventional coating handling systems rely on workers to measure, transfer, mix, and dispose of resin, catalyst and cured material waste, or hold and/or maneuver bulky applicators, which diminishes employee productivity. Tenfold or greater time savings are possible in one embodiment.

In one embodiment, worker contact with hazardous material is minimized or even eliminated.

One embodiment provides a device for applying a single or multi-component coating, which comprises: an actuator comprising at least one universal attachment port for connecting to one or more of a spray attachment, brush, applicator pad, or roller; a throughway for securing and/or positioning at least one tube in or on the actuator; and a trigger for controlling a remote coating liquid dispensing system, the tube capable of fluidly conducting one or more coating liquids from the remote coating liquid dispensing system to the spray attachment, brush, applicator pad, or roller.

One embodiment provides a device for applying a single or multi-component coating, which comprises: an actuator comprising at least one universal attachment port for connecting to one or more of a spray attachment, brush, applicator pad, or roller; a throughway for securing and/or positioning at least one tube in or on the actuator; and a trigger for controlling a remote coating liquid dispensing system, the tube capable of fluidly conducting one or more coating liquids from the remote coating liquid dispensing system to the universal attachment port.

One embodiment provides a device for applying a single or multi-component coating, which comprises: an actuator comprising at least one universal attachment port for connecting to one or more of a spray attachment, brush, applicator pad, or roller; a throughway for securing and/or positioning at least one tube in or on the actuator; and a trigger for controlling a remote coating liquid dispensing system, the tube capable of fluidly conducting one or more coating liquids from the remote coating liquid dispensing system to the actuator.

One embodiment provides a device for applying a single or multi-component coating, which comprises: an actuator comprising at least one universal attachment port for connecting to one or more of a spray attachment, brush, applicator pad, or roller; a throughway for securing and/or positioning at least one tube in or on the actuator; and a trigger for controlling a remote coating liquid dispensing system, the tube capable of fluidly conducting one or more coating liquids from the remote coating liquid dispensing system to the universal attachment port, wherein the remote dispensing system comprises a pneumatic device for delivering a single or multi-component coating liquid from one or more preloaded paint cartridges and/or packages.

One embodiment provides a device for applying a single or multi-component coating, which comprises: an actuator comprising at least one universal attachment port for connecting to one or more of a spray attachment, brush, applicator pad, or roller; a throughway for securing and/or positioning at least one tube in or on the actuator; and a trigger for controlling a remote coating liquid dispensing system, the tube capable of fluidly conducting one or more coating liquids from the remote coating liquid dispensing system to the universal attachment port, wherein the trigger controls the remote dispensing system via electronic wireless signal.

One embodiment provides a device for applying a single or multi-component coating, which comprises: an actuator comprising at least one universal attachment port for connecting to one or more of a spray attachment, brush, applicator pad, or roller; a throughway for securing and/or positioning at least one tube in or on the actuator; and a trigger for controlling a remote coating liquid dispensing system, the tube capable of fluidly conducting one or more coating liquids from the remote coating liquid dispensing system to the universal attachment port, wherein the trigger controls the remote dispensing system via pneumatic pressure.

One embodiment provides a device for applying a single or multi-component coating, which comprises: an actuator comprising at least one universal attachment port for connecting to one or more of a spray attachment, brush, applicator pad, or roller; a throughway for securing and/or positioning at least one tube in or on the actuator; and a trigger for controlling a remote coating liquid dispensing system, the tube capable of fluidly conducting one or more coating liquids from the remote coating liquid dispensing system to the universal attachment port, wherein the trigger controls an amount and/or flow of a single or multi-component paint from the remote dispensing system and controls the amount and flow of single or multi-component paint that is supplied to the a spray gun, brush, applicator pad, or roller.

One embodiment provides a device for applying a single or multi-component coating, which comprises: an actuator comprising at least one universal attachment port for connecting to one or more of a spray attachment, brush, applicator pad, or roller; a throughway for securing and/or positioning at least one tube in or on the actuator; and a trigger for controlling a remote coating liquid dispensing system, the tube capable of fluidly conducting one or more coating liquids from the remote coating liquid dispensing system to the universal attachment port, wherein the universal attachment port comprises a Luer lock fitting, a coupling, a quick connect, a screw thread (male or female), a slip fitting, a bayonet fitting, cam and groove locking quick coupling, cam operated coupling, barbed fitting, push in fitting, adapter, bulkhead fitting, caps compression fittings, crimp socket, ferrule-type fitting, or the like, or any combination thereof, for attachment to one or more of the spray attachment, brush, applicator pad, or roller; and wherein the spray attachment, brush, applicator pad, or roller comprises the complementary or corresponding portion of the Luer lock fitting, the coupling, quick connect, the screw thread (male or female), the slip fitting, the bayonet fitting, cam and groove locking quick coupling, cam operated coupling, barbed fitting, push in fitting, adapter, bulkhead fitting, caps compression fittings, crimp socket, ferrule-type fitting, or the like, or any combination thereof.

One embodiment provides a device for applying a single or multi-component coating, which comprises: an actuator comprising at least one universal attachment port for connecting to one or more of a spray attachment, brush, applicator pad, or roller; a throughway for securing and/or positioning at least one tube in or on the actuator; and a trigger for controlling a remote coating liquid dispensing system, the tube capable of fluidly conducting one or more coating liquids from the remote coating liquid dispensing system to the universal attachment port, wherein one or more of the tube, the throughway, or the universal attachment port further comprises an anti-drip mechanism.

In one embodiment, the tube and/or coating liquid passes through the universal attachment port to supply coating liquid to the brush, roller, pad, or spray attachment. In this regard, the universal attachment port can be conserved to be part of the throughway and also functions as an attachment point between the actuator device and the brush, roller, pad, or spray attachment.

In another embodiment, the tube or coating liquid do not pass through the universal attachment port. The universal attachment port functions as an attachment point and is not considered to be part of the throughway. The throughway may be located on or through a different part of the actuator.

In one embodiment, the brush, roller, pad, or spray attachment receives the coating liquid through the universal attachment port, and is also attached to the actuator via the universal attachment port. In this regard, the brush, roller, pad, or spray attachment can be considered to be attached to the throughway and the universal attachment port.

In another embodiment, the brush, roller, pad, or spray attachment does not receive the coating liquid through the universal attachment port, but is nevertheless attached to the actuator via the universal attachment port. In this regard, the brush, roller, pad, or spray attachment receives the coating liquid through the tube or throughway, which may be located on a different part of the actuator. Further, in this regard, the tube is capable of fluidly conducting one or more coating liquids from the remote coating liquid dispensing system to the throughway or to the brush, roller, pad, or spray attachment and not to the universal attachment port.

In one embodiment, the throughway is optional. In another embodiment, the universal attachment port functions as both the throughway and the attachment point for the brush, roller, pad, or spray attachment.

In another embodiment, the universal attachment port functions as the attachment point for the brush, roller, pad, or spray attachment, and the actuator does not have a throughway. In one embodiment, the universal attachment port functions as the attachment point for the brush, roller, pad, or spray attachment, and the throughway is present in or on the brush, roller, pad, or spray device.

In one embodiment, the tube is an integral part of the actuator, being formed merely by an opening therein, and is not a separate tube. For example, the tube may be merely an opening through the actuator body, the universal attachment port, or the throughway, or a combination thereof.

One embodiment includes the spray attachment.

One embodiment includes the paint roller.

One embodiment of the paint roller includes a perforated roller having an interior fluid communication port fluidly connected to the paint feed tube with the actuator.

One embodiment of the paint roller includes a perforated roller wherein the coating liquid coats the inside or outside of the roller.

One embodiment of the spray attachment, brush, applicator pad, or roller includes an anti-drip mechanism.

One embodiment includes the brush.

One embodiment of the brush includes an internal fluid delivery port in fluid communication with the actuator.

One embodiment includes the brush wherein the fluid coats the inside of the brush.

One embodiment of the brush includes an anti-drip mechanism.

One embodiment of the spray attachment comprises a spray nozzle.

One embodiment of the spray attachment comprises a spray gun

One embodiment of the spray attachment includes an internal fluid delivery port in fluid communication with the remote coating liquid dispensing system.

One embodiment of the spray attachment includes an anti-drip mechanism.

One embodiment of the anti-drip mechanism reduces or substantially prevents drips between two or more of the remote coating liquid dispensing system, the actuator, the throughway, the universal attachment port, the tube, the spray attachment, the brush, the roller, the applicator pad, the static mixer, the cartridge, or any combination thereof.

One embodiment of the anti-drip mechanism reduces or substantially prevents drips downstream from one or more of the remote coating liquid dispensing system, the actuator, the throughway, the universal attachment port, the tube, the spray attachment, the brush, the roller, the applicator pad, the static mixer, the cartridge, or any combination thereof.

One embodiment includes a method for coating a substrate using the actuator.

One embodiment of the spray attachment includes a spray nozzle and a separate atomization gas line for atomizing the coating liquid from the spray tip and to spray the coating.

One embodiment provides an actuator device for applying a single or multi-component coating, which comprises: at least one universal attachment port configured to connect to one or more of a spray attachment, brush, applicator pad, or roller; a throughway configured to secure and/or position at least one feed tube in or on the actuator; and a trigger configured to control a remote coating liquid dispensing system, wherein when in operation the feed tube is capable of fluidly conducting one or more coating liquids from the remote coating liquid dispensing system to one or more selected from the group consisting of the spray attachment, brush, applicator pad, roller, actuator, universal attachment port, or a combination thereof.

In one embodiment, the trigger controls the remote coating liquid dispensing system via electronic wireless signal.

In one embodiment, the trigger controls the remote coating liquid dispensing system via pneumatic pressure.

In one embodiment, the universal attachment port comprises at least one attachment selected from the group consisting of Luer lock fitting, coupling, quick connect, screw thread, slip fitting, bayonet fitting, cam and groove locking quick coupling, cam operated coupling, barbed fitting, push in fitting, adapter, bulkhead fitting, caps compression fittings, crimp socket, ferrule-type fitting, or a combination thereof, the attachment configured to attach to a corresponding attachment on one or more of the spray attachment, brush, applicator pad, roller, or combination thereof.

In one embodiment, the actuator device comprises a switch connected to the trigger, and the switch is configured to communicate with the remote coating liquid dispensing system.

In one embodiment, the actuator device comprises a switch and a switch pin, wherein the switch is connected to the trigger through the switch pin, and the switch is configured to communicate with the remote coating liquid dispensing system.

In one embodiment, the switch comprises a pneumatic valve configured to control an amount or flow of a pneumatic pressure to the remote coating liquid dispensing system, and when in operation the pneumatic pressure controls the amount or flow of one or more coating liquids from the remote coating liquid dispensing system to the spray attachment, brush, applicator pad, roller, actuator, universal attachment port, or a combination thereof.

In one embodiment, the switch comprises a wireless transmitter configured to deliver a wireless signal to the remote coating liquid dispensing system, and when in operation the wireless signal controls the amount or flow of one or more coating liquids from the remote coating liquid dispensing system to the spray attachment, brush, applicator pad, roller, actuator, universal attachment port, or a combination thereof.

In one embodiment, the throughway is configured to secure or position the tube through an interior portion of the actuator, an exterior portion of the actuator, or combination thereof.

One embodiment provides an actuator device for applying a single or multi-component coating, which comprises: at least one universal attachment port configured to connect to one or more of a spray attachment, brush, applicator pad, or roller; a trigger configured to control a remote coating liquid dispensing system, wherein when in operation the feed tube is capable of fluidly conducting one or more coating liquids from the remote coating liquid dispensing system to one or more selected from the group consisting of the spray attachment, brush, applicator pad, roller, actuator, universal attachment port, or a combination thereof.

One embodiment provides a first coating system, comprising: the actuator device; and at least one coating attachment attached to the universal attachment port, and selected from the group consisting of spray attachment, brush, applicator pad, roller, or a combination thereof.

One embodiment provides a second coating system, comprising: the actuator device; at least one coating attachment attached to the universal attachment port, and selected from the group consisting of spray attachment, brush, applicator pad, roller, or a combination thereof; and at least one remote coating liquid dispensing system.

In one embodiment, the coating system comprises at least one static mixer located upstream of the coating attachment and fluidly connected to the coating attachment.

In one embodiment, the coating system comprises at least one anti-drip valve located upstream of the coating attachment and fluidly connected to the coating attachment.

In one embodiment, the coating system comprises a pumping source configured to provide pneumatic pressure to at least one selected from the group consisting of the remote coating liquid dispensing system, actuator device, coating attachment, or combination thereof.

In one embodiment, the coating system comprises a pumping source configured to provide pneumatic pressure to at least one selected from the group consisting of the remote coating liquid dispensing system, actuator device, coating attachment, or combination thereof, and a second pumping source configured to supply atomization gas to the coating attachment.

In one embodiment, the pumping source is configured to provide pressurized gas and is selected from the group consisting of pneumatic source, bottled gas, gas compressor, house gas, or combination thereof.

One embodiment provides a method, comprising applying a coating to a surface using the actuator device.

One embodiment provides a method, comprising applying a coating to a surface using the coating system.

Some examples of applications for the actuator, which are not intended to be limiting, include bridge & manhole repair, railcar, wind generation equipment, truck and bed liners, tank linings, pool & deck coatings, floor coatings, general industrial, marine & offshore, military, automotive, aerospace, construction, pipeline, and the like.

The entire contents of each of U.S. Pat. No. 7,144,170, issued Dec. 5, 2006; references cited therein; U.S. Provisional Application No. 60/533,973, filed Jan. 2, 2004; U.S. Provisional Application No. 60/551,200; U.S. Pat. No. 5,725,499, issued Mar. 10, 1998; U.S. Pat. No. 6,601,782, issued Aug. 5, 2003; and U.S. Patent Publication No. 20060144854, published Jul. 6, 2006, are hereby incorporated by reference.

1. An actuator device for applying a single or multi-component coating, which comprises:
at least one universal attachment port configured to connect to one or more of a spray attachment, brush, applicator pad, or roller;
a throughway configured to secure and/or position at least one feed tube in or on the actuator;
and a trigger configured to control a remote coating liquid dispensing system, wherein when in operation the feed tube is capable of fluidly conducting one or more coating liquids from the remote coating liquid dispensing system to one or more selected from the group consisting of the spray attachment, brush, applicator pad, roller, actuator, universal attachment port, or a combination thereof.

2. The actuator device according to claim 1, wherein the trigger controls the remote coating liquid dispensing system via electronic wireless signal.

3. The actuator device according to claim 1, wherein the trigger controls the remote coating liquid dispensing system via pneumatic pressure.

4. The actuator device according to claim 1, wherein the universal attachment port comprises at least one attachment selected from the group consisting of Luer lock fitting, coupling, quick connect, screw thread, slip fitting, bayonet fitting, cam and groove locking quick coupling, cam operated coupling, barbed fitting, push in fitting, adapter, bulkhead fitting, caps compression fittings, crimp socket, ferrule-type fitting, or a combination thereof, the attachment configured to attach to a corresponding attachment on one or more of the spray attachment, brush, applicator pad, roller, or combination thereof.

5. The actuator device according to claim 1, further comprising a switch connected to the trigger, and wherein the switch is configured to communicate with the remote coating liquid dispensing system.

6. The actuator device according to claim 1, further comprising a switch and a switch pin, wherein the switch is connected to the trigger through the switch pin, and wherein the switch is configured to communicate with the remote coating liquid dispensing system.

7. The actuator device according to claim 1, wherein the switch comprises a pneumatic valve configured to control an amount or flow of a pneumatic pressure to the remote coating liquid dispensing system, and wherein when in operation the pneumatic pressure controls the amount or flow of one or more coating liquids from the remote coating liquid dispensing system to the spray attachment, brush, applicator pad, roller, actuator, universal attachment port, or a combination thereof.

8. The actuator device according to claim 1, wherein the switch comprises a wireless transmitter configured to deliver a wireless signal to the remote coating liquid dispensing system, and wherein when in operation the wireless signal controls the amount or flow of one or more coating liquids from the remote coating liquid dispensing system to the spray attachment, brush, applicator pad, roller, actuator, universal attachment port, or a combination thereof.

9. The actuator device according to claim 1, wherein the throughway is configured to secure or position the tube through an interior portion of the actuator, an exterior portion of the actuator, or combination thereof.

10. An actuator device for applying a single or multi-component coating, which comprises:
at least one universal attachment port configured to connect to one or more of a spray attachment, brush, applicator pad, or roller; and
a trigger configured to control a remote coating liquid dispensing system.

11. A first coating system, comprising:
the actuator device according to claim 1; and
at least one coating attachment attached to the universal attachment port, and selected from the group consisting of spray attachment, brush, applicator pad, roller, or a combination thereof.

12. The coating system according to claim 11, further comprising
at least one remote coating liquid dispensing system.

13. The coating system according to claim 11, further comprising at least one static mixer located upstream of the coating attachment and fluidly connected to the coating attachment.

14. The coating system according to claim 11, further comprising at least one anti-drip valve located upstream of the coating attachment and fluidly connected to the coating attachment.

15. The coating system according to claim 11, further comprising a pumping source configured to provide pneumatic pressure to at least one selected from the group consisting of the remote coating liquid dispensing system, actuator device, coating attachment, or combination thereof.

16. The coating system according to claim 11, further comprising a pumping source configured to provide pneumatic pressure to at least one selected from the group consisting of the remote coating liquid dispensing system, actuator device, coating attachment, or combination thereof, and a second pumping source configured to supply atomization gas to the coating attachment.

17. The coating system according to claim 11, wherein the pumping source is configured to provide pressurized gas and is selected from the group consisting of pneumatic source, bottled gas, gas compressor, house gas, or combination thereof.

18. A method, comprising applying a coating to a surface using the actuator device according to claim 1.

19. A method, comprising applying a coating to a surface using the coating system according to claim 11.
